(19) United States
(12) Patent Application Publication
(10) Pub. No.: US 2025/0109241 A1
(43) Pub. Date: Apr. 3, 2025

(54) EPOXY RESIN COMPOSITIONS AND METHODS OF PRODUCING THEREOF

(71) Applicant: Westlake Epoxy Inc., Houston, TX (US)

(72) Inventors: Martin FULGRAFF, Herne (DE); Lambert MAES, Kevelaer (DE); Isabella MAZURCZYK, Gladbeck (DE); Tareq HASSON, Ratingen (DE)

(21) Appl. No.: 18/903,336

(22) Filed: Oct. 1, 2024

Related U.S. Application Data
(60) Provisional application No. 63/542,156, filed on Oct. 3, 2023.

(51) Int. Cl. C08G 59/22; C08G 59/50

(52) U.S. Cl. CPC C08G 59/226; C08G 59/5026

(57) ABSTRACT

Embodiments of the present disclosure generally relate to epoxy resin compositions and uses thereof. The epoxy resin compositions include an epoxy component including a first epoxy compound and a second epoxy compound. The epoxy resin compositions include a curing agent component including a first polyamine compound and a second polyamine compound.

### CROSS-REFERENCE TO RELATED APPLICATIONS

This application claims benefit to U.S. Prov. Appl. No. 63/542,156, filed on Oct. 3, 2023, which is herein incorporated by reference in its entirety.

### FIELD

Embodiments of the present disclosure generally relate to epoxy resin compositions and uses thereof.

### BACKGROUND

Structural aerospace components are often made in batch processes that incorporate mono-component resin compositions, such as RTM6, Cycom 890, or EPS 600, which includes a pre-mixture of resins and hardening agents. Unfortunately, mono-component resin compositions lack temperature stability at temperature of greater than about −18° C. as well as have long curing times, such as about 90 min to about 120 min, once applied to the structural aerospace components. Conventionally, cold storage and transport, such as below −18° C., has been implemented. However, an increase in the cost of storage and transport has been observed. Moreover, the cold temperatures of the storage and transport has been shown to alter one or more properties, such as viscosity, requiring pre-heating of the mono-component resin compositions, which increases processing time and reduces the number of parts that may be produced in a given period of time.

Conventional approaches to reduce processing time and reduce the need for cold storage and transport has focused on producing a bi-component resin composition. A bi-component resin composition includes a resin and a hardening agent that are packaged as separate components, and mixed prior to processing of the structural aerospace component. While two-component compositions may eliminate the pre-heating requirement and reduce some expenses relating to storage and transport of the resin system, the curing time remains long, such as about 60 minutes to about 120 minutes. Moreover, conventional bi-component resin compositions often relied on chemicals that may be subject to regulatory scrutiny. Previous attempts to reduce the use of such chemicals and/or reduce the curing time, such as about 2 min to about 5 min, of the conventional bi-functional resin compositions also reduced the glass transition temperature of the crosslinked epoxy resin to a temperature of about 120° C., as compared to the conventional glass transition temperature of about 140° C. or greater that is used for structural aerospace components. Indeed, a reduction of the glass transition temperature may result in a crosslinked epoxy resin failure when operating at temperatures greater than the reduced glass transition temperature.

Accordingly, there is a need for new and improved bi-component resin compositions that provide a reduced curing time and yield a high glass transition temperature.

### SUMMARY

Embodiments of the present disclosure generally relate to epoxy resin compositions and uses thereof.

In some embodiments, the present disclosure provides an epoxy resin composition including an epoxy component including a first epoxy compound that is a bisphenol A diglycidyl ether compound and a second epoxy compound that is a diglycidyl aniline compound. The epoxy resin composition includes a curing agent component including a first polyamine compound and a second polyamine compound. The second polyamine compound is an adduct of the first polyamine compound.

In some embodiments, the present disclosure also provides a crosslinked epoxy resin composition that is the reaction product of an epoxy component including a first epoxy compound that is a bisphenol A diglycidyl ether compound and a second epoxy compound that is a diglycidyl aniline compound, and a curing agent component including a first polyamine compound and a second polyamine compound. The second polyamine compound is an adduct of the first polyamine compound.

In some embodiments, the present disclosure also provides a method of forming a crosslinked epoxy resin composition. The method includes producing a mixture by providing an epoxy component and a curing agent component into a resin transfer molding system. The epoxy component includes a first epoxy compound that is a bisphenol A diglycidyl ether compound and a second epoxy compound that is a diglycidyl aniline compound. The curing agent component includes a first polyamine compound and a second polyamine compound. The second polyamine compound is an adduct of the first polyamine compound. A component is disposed in the resin transfer molding system. The mixture is disposed on the component. The crosslinked epoxy resin composition is formed by curing the mixture on the component at a temperature of about 120° C. to about 180° C. for a period of about 10 minutes to about 30 minutes.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 is a graphical representation of viscosity vs. temperature of the resin component, according to embodiments of the disclosure.

FIG. 2 is a graphical representation of viscosity vs. time of a resin component at 80° C., according to embodiments of the disclosure.

FIG. 3 is a graphical representation of viscosity vs. temperature of the curing agent component, according to embodiments of the disclosure.

FIG. 4 is a graphical representation of viscosity vs. time of a curing agent component at 80° C., according to embodiments of the disclosure.

FIG. 5 is a graphical representation of a hot plate gel time vs. temperature of an epoxy resin, according to embodiments of the disclosure.

FIG. 6 is a graphical representation of a viscosity vs. time of an epoxy resin, according to embodiments of the disclosure.

FIG. 7 is a graphical representation of a viscosity vs. time of an epoxy resin at varying temperatures, according to embodiments of the disclosure.

FIG. 8 is a graphical representation of a refractive index vs. stoichiometry deviation of an epoxy resin composition, according to embodiments of the disclosure.

FIG. 9 is a graphical representation of a glass transition temperature (T_{g}) onset vs. stoichiometry deviation of an epoxy resin composition, according to embodiments of the disclosure.

FIG. 10 is a graphical representation of mechanical properties of an epoxy resin composition, according to embodiments of the disclosure.

### DETAILED DESCRIPTION

Embodiments of the present disclosure generally relate to epoxy resin compositions and uses thereof. In some embodiments, the present disclosure provides an epoxy resin composition comprising an epoxy component comprising a first epoxy compound that is a bisphenol A diglycidyl ether compound and a second epoxy compound that is a diglycidyl aniline compound. The epoxy resin composition includes a curing agent component comprising a first polyamine compound and a second polyamine compound. The second polyamine compound is an adduct of the first polyamine compound. Without being bound by theory, a reduction of curing time can be achieved using the epoxy resin compositions described herein, such as a curing time of about 10 minutes (min) to about 30 min, such as about 10 min to about 15 min, about 15 min to about 20 min, about 20 min to about 25 min, or about 25 min to about 30 min. The crosslinked epoxy resin compositions maintain a high dry glass transition temperature (T_{g}) onset, such as greater than 160° C. as well as a high wet T_{g} onset, such as greater than 140° C., to allow for applications in the aerospace industry, which allows for chemical properties such as tensile strength, thermal expansion, heat capacity, modulus, and/or electrical properties to be maintained or improved in the crosslinked epoxy resin. The epoxy resin compositions have an improved gelation time compared to conventional bi-component resin compositions, which promotes safe chemical reactions during the formation of the crosslinked epoxy resin. Overall, the crosslinked epoxy resin compositions of the present disclosure can provide a high T_{g} onset, such as greater than 140° C., and a short cure time with limited to no deformation, porosities, shrinkage, and/or exothermic burned areas.

For example, by using an epoxy component comprising at least two epoxy compounds including bisphenol A diglycidyl ether and tetraglycidylmethylenedianiline and a curing agent component having at least two curing formulations including isophorone diamine and an isophorone diamine adduct, an epoxy resin formulation was produced that had a fast cure time as well as a high dry T_{g} onset and a high wet T_{g} onset.

### Epoxy Resin Compositions

Epoxy resin compositions of the present disclosure include an epoxy component and a curing agent component. Compositions of the present disclosure can further include additional additives, such as sand, fibers, fillers, thickeners, tougheners, flame retardants, stabilizers, or a combination thereof. Compositions can be formulated with the following components, where the wt % of each component is based on % weight basis, and a total wt % of the epoxy resin composition not to exceed 100 wt %. As used herein, an epoxy resin composition can include the components of the composition (such as epoxy component, curing agent component, additional additive, etc.) and/or reaction product(s) of two or more components of the composition. A crosslinked epoxy resin composition has an increased amount of reaction product(s) as compared to a non-crosslinked epoxy resin composition.

An amount of the epoxy component in the epoxy resin composition can be from about 60 wt % to about 80 wt %, such as about 60 wt % to about 65 wt %, about 65 wt % to about 70 wt %, about 70 wt % to about 75 wt %, or about 75 wt % to about 80 wt %, based on the combined weight of epoxy component and curing agent component. In at least one embodiment, the amount (wt %) of the epoxy component in the epoxy resin composition is about 60, 61, 62, 63, 64, 65, 66, 67, 68, 69, 70, 71, 72, 73, 74, 75, 76, 77, 78, 79, 80, or ranges thereof, though higher or lower amounts are contemplated.

An amount of curing agent component in the epoxy resin composition can be from about 20 wt % to about 40 wt %, such as about 20 wt % to about 25 wt %, about 25 wt % to about 30 wt %, about 30 wt % to about 35 wt %, or about 35 wt % to about 40 wt %, based on the combined weight of epoxy composition and curing agent component. In at least one embodiment, the amount (wt %) of the curing agent component in the epoxy resin composition is about 20, 21, 22, 23, 24, 25, 26, 27, 28, 29, 30, 31, 32, 33, 34, 35, 36, 37, 38, 39, 40, or ranges thereof, though higher or lower amounts are contemplated.

Epoxy resin compositions of the present disclosure include an amount of the epoxy component (epoxy compounds) and the amount of the curing agent component. For such embodiments, a molar ratio of the epoxy component to the curing agent component is from about 2:1 mol/mol to about 3:1 mol/mol. In some embodiments, the molar ratio of the epoxy component to the curing agent component is from about 2.2:1 mol/mol, 2.4:1 mol/mol, 2.6:1 mol/mol, 2.8:1 mol/mol, or 3.0:1 mol/mol, or ranges thereof, though higher or lower molar ratios are contemplated.

The molar ratio of the epoxy component to the curing agent component is based on functional equivalence (reactive groups present in each component). That is, the molar ratio refers to the molar quantities of (epoxy group):(active hydrogens located on the groups (such as amine groups) of the curing agent component).

### Epoxy Components

The epoxy resin composition includes an epoxy component. The epoxy component includes a first epoxy compound and a second epoxy compound. In at least one embodiment, at least one of the first epoxy compound or second epoxy compound is independently a bis-phenol A diglycidyl ether epoxy resin compound (CAS No. 1675-54-3). For example, bis-phenol A diglycidyl ether epoxy resins can include bis-[4-(2,3-epoxipropoxi)phenyl]propane. Commercial bis-phenol A diglycidyl ether epoxy resins may include EPIKOTE™ LVEL 828 resin and/or EPON® 828 resin (available from Westlake Epoxy), DER 331 (available from Dow Chemicals), Araldite 6010 (available from Huntsman), and Epotuf 37-140 (available from Reichhold Chemical Co.). For example, a bis-phenol A diglycidyl ether epoxy resin can include 4,4′-isopropylidenediphenol-epichlorohydrin copolymer, propane, 2,2-bis[p-(2,3-epoxypropoxy)phenyl], phenol, 4,4′-(1-methylethylidene)bis-polymer with (chloromethyl)oxirane, or diglycidyl ether of Bisphenol A homopolymer.

In at least one embodiment, at least one of the first epoxy compound or second epoxy compound is independently a diglycidyl aniline such as a tetraglycidyl methylene dianiline compound. Commercial tetraglycidyl methylene dianiline epoxy resins may include EPIKOTE™ 496 and/or EPON® 496 resin (available from Westlake Epoxy). As a further example, a tetraglycidyl methylene dianiline compound can include 4,4′-methylenebis[N,N-bis(2,3-epoxypropyl)aniline](CAS No. 28768-32-3) or tetragycidylmethylenedianiline.

In at least one embodiment, each of the first epoxy compound, second epoxy compound, or third epoxy compound may independently be a tetramethyl bisphenol F-diglycidyl ether compound (CAS No. 113693-69-9). For example, a tetramethyl bisphenol F-diglycidyl ether can include 4,4′methylenebis(2,6-dimethylphenol) (CAS No. 93705-66-9)

For example, the first epoxy compound can be a bisphenol A diglycidyl ether compound, such as bis-[4-(2,3-epoxipropoxi)phenyl]propane, the second epoxy compound can be a tetramethyl bisphenol F-diglycidyl ether compound, and the third epoxy compound can be a tetraglycidyl methylene dianiline compound, such as 4,4′-methylenebis[N,N-bis(2,3-epoxypropyl)aniline].

The first epoxy compound and the second epoxy compound may, independently, have a weight percent of about 20 wt % to about 80 wt % of the epoxy component, such as about 20 wt % to about 35 wt %, about 25 wt % to about 40 wt %, about 40 wt % to about 55 wt %, or about 25 wt % to about 80 wt %, based on total weight of the first epoxy compound and the second epoxy compound in the epoxy component. In at least one embodiment, the amount (wt %) of the first epoxy compound in the epoxy component is about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 70, 80, or ranges thereof, though higher or lower amounts are contemplated.

For example, the first epoxy compound has a weight percent of about 20 wt % to about 30 wt %, such as about 20 wt % to about 23 wt %, about 23 wt % to about 26 wt %, or about 26 wt % to about 30 wt % and the second epoxy compound has a weight percent of about 20 wt % to about 60 wt %, such as about 20 wt % to about 33 wt %, about 33 wt % to about 46 wt %, or about 46 wt % to about 60 wt %, where the total of the first compound and the second compound does not exceed 100 wt %.

In at least one embodiment, the epoxy component may include a third epoxy compound. The third epoxy compound may have a weight percent of about 20 wt % to about 80 wt % of the epoxy component, such as about 20 wt % to about 35 wt %, about 25 wt % to about 40 wt %, about 40 wt % to about 55 wt %, or about 25 wt % to about 60 wt %, based on total weight of the first epoxy compound and the second epoxy compound in the epoxy component. In at least one embodiment, the amount (wt %) of the first epoxy compound in the epoxy component is about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 70, 80, or ranges thereof, though higher or lower amounts are contemplated.

For example, the epoxy component includes a first epoxy compound, a second epoxy compound, and a third epoxy compound, where the first epoxy compound has a weight percent of about 20 wt % to about 30 wt % of the total weight of the epoxy component, such as about 20 wt % to about 23 wt %, about 23 wt % to about 26 wt %, or about 26 wt % to about 30 wt %, the second epoxy compound has a weight percent of about 20 wt % to about 60 wt % of the total weight of the epoxy component, such as about 20 wt % to about 33 wt %, about 33 wt % to about 46 wt %, or about 46 wt % to about 60 wt %, and the third epoxy compound has a weight percent of about 25 wt % to about 55 wt % of the total weight of the epoxy component, such as about 20 wt % to about 453 wt %, about 43 wt % to about 56 wt %, about 56 wt % to about 60 wt %, where the total of the first compound, the second compound, and the third compound does not exceed 100 wt %. As a further example, the epoxy component may include a first epoxy compound, a second epoxy compound, and a third epoxy compound, where the first epoxy compound has a weight percent of about 14 wt % to about 25 wt % of the total weight of the epoxy resin composition, such as about 14 wt % to about 18 wt %, about 18 wt % to about 22 wt %, or about 22 wt % to about 25 wt %, the third epoxy compound has a weight percent of about 14 wt % to about 25 wt % of the total weight of the epoxy resin composition, such as about 14 wt % to about 18 wt %, about 18 wt % to about 22 wt %, or about 22 wt % to about 25 wt %, and the second epoxy compound has a weight percent of about 30 wt % to about 41 wt % of the total weight of the epoxy resin composition, such as about 30 wt % to about 34 wt %, about 34 wt % to about 38 wt %, about 38 wt % to about 41 wt %, where the total of the first compound, the second compound, and the third compound does not exceed 100 wt %.

In at least one embodiment, each of the first epoxy compound, second epoxy compound, or third epoxy compound may have a weight average molecular weight (Mw) of about 340 g/mol to about 470 g/mol and an epoxy equivalent weight of about 170 g/mol to about 235 g/mol, such as a weight average molecular weight of about 360 g/mol to about 390 g/mol and an epoxy equivalent weight of about 180 g/mol to about 195 g/mol, or a weight average molecular weight of about 360 g/mol to about 384 g/mol and an epoxy equivalent weight of about 185 g/mol to about 192 g/mol. “Epoxy equivalent weight”, as used herein, refers to the molecular weight of the epoxy compound divided by the number of epoxy groups present in the compound.

### Curing Agent Component

Epoxy resin compositions of the present disclosure have a curing agent component. The curing agent component includes a first curing formulation and a second curing formulation. The first curing formulation and the second curing formulation can independently include one or more of a primary amine, a secondary amine, a tertiary amine, polyamine, aliphatic polyamine, cycloaliphatic amine, aromatic amine (such as imidazoles), anhydride, mercaptan, isocyanate, Mannich base, ketimine, oxazoline, amidoamine, modified polyamine resin prepared by reacting aliphatic or cycloaliphatic polyamines with compounds containing functional groups which react with the amine group, such as glycidyl ether-containing or carboxy-containing compounds, or a combination thereof.

In an embodiment, the first curing formulation and the second formulation may independently be a polyamine having a weight average molecular weight (Mw) of about 15 g/mol to about 2000 g/mol, such as from about 25 g/mol to about 1000 g/mol, such as from about 35 g/mol to about 500 g/mol. In at least one embodiment, the Mw (g/mol) of the one or more polyamines is about 15, 25, 50, 100, 150, 200, 250, 300, 350, 400, 450, 500, 550, 600, 650, 700, 750, 800, 850, 900, 950, or 1000, or ranges thereof, though higher or lower values are contemplated. For example, the first curing formulation and the second formulation may independently be 1,3-bis(aminomethyl)cyclohexane, diethylenetriamine, triethylenetetramine, hexamethylenediamine, trimethylhexamethylenediamine, tetraethylenepentaamine, N,N′-dimethylpropylenediamine, 1,3-bis(4-amino-3-methylcyclohexyl)methane, bis(p-aminocyclohexyl)methane, 2,2-bis(4-aminocyclohexyl)propane, 3,5,5-trimethyl-3-(aminomethyl)-cyclohexylamine (CAS No. 2855-13-2), N-aminoethlpiperazine, m-phenylenediamine, p-phenylenediamine, bis(p-aminophenyl)methane, bis(p-aminophenyl)sulfone, m-xylylenediamine, 1,2-diaminocyclohexane, 1,4-diaminocyclohexane, 1,4-bis(aminomethyl)cyclohexane, phenol,4,4′-(1-methylethylidene)bis-polymer with 5-amino-1,3,3-trimethylcyclohexanemethanamine and (chloromethyl)oxirane (CAS No. 38294-64-3), and combinations thereof.

In an embodiment, the first curing formulation is a polyamine including an isophorone diamine compound such as 3,5,5-trimethyl-3-(aminomethyl)-cyclohexylamine. As a further example, the second curing formulation is a combination of a first polyamine including an isophorone diamine compound such as 3,5,5-trimethyl-3-(aminomethyl)-cyclohexylamine, and a second polyamine including an isophorone diamine adduct compound such as phenol,4,4′-(1-methylethylidene)bis-polymer with 5-amino-1,3,3-trimethylcyclohexanemethanamine and (chloromethyl)oxirane. Other suitable polyamines include any suitable amine functionalized polymer including, but not limited to, aminosilanes, amine-diacid adducts (industrially known as polyamidoamines), and amine-epoxy adducts.

The first curing formulation may have a weight percent of about 30 wt % to about 80 wt % of the curing agent component, such as about 30 wt % to about 45 wt %, about 45 wt % to about 60 wt %, about 60 wt % to about 75 wt %, or about 75 wt % to about 80 wt %, based on total weight of the first curing formulation and the second curing formulation in the curing agent component. In at least one embodiment, the amount (wt %) of the first curing formulation in the curing agent component is about 30, 31, 32, 33, 34, 35, 36, 37, 38, 39, 40, 41, 42, 43, 44, 45, 46, 47, 48, 49, 50, or ranges thereof, though higher or lower amounts are contemplated.

The second curing formulation may have a weight percent of about 50 wt % to about 70 wt % of the curing agent component, such as about 50 wt % to about 55 wt %, about 55 wt % to about 60 wt %, about 60 wt % to about 65 wt %, or about 65 wt % to about 70 wt %, based on total weight of the first curing formulation and the second curing formulation in the curing agent component. In at least one embodiment, the amount (wt %) of the first curing formulation in the curing agent component is about 50, 51, 52, 53, 54, 55, 56, 57, 58, 59, 60, 61, 62, 63, 64, 65, 66, 67, 68, 69, 70, or ranges thereof, though higher or lower amounts are contemplated. For example, the first curing formulation may have a weight percent of about 30 wt % to about 50 wt % of the curing agent component, and the second curing formulation may have a weight percent of about 50 wt % to about 70 wt % of the curing agent component.

In an embodiment, the first curing formulation may be 100 wt % of an isophorone diamine, such as 3-aminomethyl-3,5,5-trimethylcyclohexylamine. In an embodiment, the second curing formulation may be a mixture of one or more polyamines. For example, the second curing formulation may include about 40 wt % to about 50 wt % of the first polyamine, such as about 40 wt % to about 43 wt %, about 43 wt % to about 46 wt %, or about 46 wt % to about 50 wt %, and about 50 wt % to about 60 wt % and about 50 wt % to about 70 wt % of a second polyamine, such as about 50 wt % to about 53 wt %, about 53 wt % to about 56 wt %, or about 56 wt % to about 70 wt %, where the total weight percent of the first polyamine and the second polyamine do not exceed 100 wt %. For example, the second curing formulation may be a mixture of about 40 wt % to about 50 wt % of a first polyamine, such as isophorone diamine such as 3,5,5-trimethyl-3-(aminomethyl)-cyclohexylamine, and about 50 wt % to about 70 wt % of a second polyamine, such as an isophorone diamine adduct such as phenol, 4,4′-(1-methylethylidene)bis-polymer with 5-amino-1,3,3-trimethylcyclohexanemethanamine and (chloromethyl)oxirane.

In an embodiment, the curing agent component may include a first curing formulation of 100 wt % 3-aminomethyl-3,5,5-trimethylcyclohexylamine and a second curing formulation including a mixture of about 48.5 wt % of 3-aminomethyl-3,5,5-trimethylcyclohexylamine and about 51.5 wt % of phenol,4,4′-(1-methylethylidene)bis-polymer with 5-amino-1,3,3-trimethylcyclohexanemethanamine and (chloromethyl)oxirane.

In an embodiment, where the curing agent component has a first curing formulation of 100 wt % of a first polyamine and a second curing formulation of a mixture of about 40 wt % to about 60 wt % of the first polyamine and about 40 wt % to about 70 wt % of a second polyamine, the first polyamine may be present in the curing agent component at a weight percent of about 50 wt % to about 80 wt %, such as about 50 wt % to about 60 wt %, about 60 wt % to about 70 wt %, or about 70 wt % to about 80 wt %. For example, the first curing formulation may be about 30 wt % to about 80 wt % of a first polyamine, such as 3-aminomethyl-3,5,5-trimethylcyclohexylamine, and the second curing formulation may be about 20 wt % to about 70 wt % of a second polyamine, such as phenol, 4,4′-(1-methylethylidene)bis-polymer with 5-amino-1,3,3-trimethylcyclohexanemethanamine and (chloromethyl)oxirane.

In an embodiment, the curing agent component includes a first polyamine compound and a second polyamine compound, where the first polyamine compound has a weight percent of about 10 wt % to about 22 wt % of the total weight of the epoxy resin composition, such as about 10 wt % to about 14 wt %, about 14 wt % to about 22 wt %, or about 15 wt % to about 22 wt %, and the second polyamine compound has a weight percent of about 5 wt % to about 10 wt % of the total weight of the epoxy resin composition, such as about 5 wt % to about 8 wt %, about 6 wt % to about 8 wt %, or about 8 wt % to about 10 wt %, where the total of the first compound, the second compound, and the third compound does not exceed 100 wt %.

Without being bound by theory, a curing agent component having a first curing formulation and a second curing formulation may reduce a cure time of the epoxy resin composition by accelerating the gelation of the curing agent component with the epoxy component. Moreover, a curing agent component having phenol,4,4′-(1-methylethylidene)bis-polymer with 5-amino-1,3,3-trimethylcyclohexanemethanamine and (chloromethyl)oxirane may reduce the reaction energy (exothermicity) of the epoxy resin composition while concurrently reducing or eliminating potential runaway reaction from occurring.

### Additives

The epoxy resin composition may include one or more additives. Such additives include one or more solvents. Suitable solvents include an organic solvent. Organic solvents can include alcohols; aliphatic, naphthenic and aromatic hydrocarbons; ethers; esters; and ketones. Illustrative, but non-limiting, examples of organic solvents include hexane, heptane, octane, methyl cyclohexane, xylene, toluene, ethyl alcohol, isopropyl alcohol, butyl alcohol, the monomethyl ether of diethylene glycol, ethylene glycol of monobutyl ether, tetrahydrofuryl alcohol, ethylene glycol monomethyl ether, ethyl acetate, isopropyl acetate, butyl acetate, amyl acetate, acetone, methyl ethyl ketone, methyl isobutyl ketone, diisobutyl ketone, and combinations thereof. Other solvents are contemplated. In some embodiments, the epoxy resin composition is free or substantially free of water. In some embodiments, the organic solvent includes n-butanol, toluene, xylene, or mixtures thereof.

In an embodiment, additives may include one or more of sand; accelerators; fillers and extenders, such as resinous modifiers, such as phenolic resins, urea resins, melamine resins, acrylic resins, polyester resins, vinyl resins, bituminous resins, and polystyrene; surfactants; UV absorbers; thickeners; tougheners, such as Kane Ace™ MX 150 (Available from Kaneka Belgium); flame retardants; stabilizers; and combinations thereof.

The amount of epoxy component, curing agent component, and/or additives used to form the epoxy resin composition can be utilized to define the molecular structure, chemical properties, and physical properties of the crosslinked epoxy resin composition.

### Crosslinked-Composition Properties

In some embodiments, a crosslinked epoxy composition has a dry T_{g} onset of about 160° C. to about 210° C., such as about 160° C. to about 170° C., about 170° C. to about 180° C., about 180° C. to about 190° C., about 190° C. to about 200° C., or about 200° C. to about 210° C. A dry T_{g} onset is a glass transition temperature that is tested in a dry environment, such as about 0% to about 10% humidity, such as about 0% to about 4%, about 4% to about 8%, or about 8% to about 10%. In some embodiments, the crosslinked epoxy composition has a wet T_{g} onset of about 140° C. to about 180° C., such as about 140° C. to about 150° C., about 150° C. to about 160° C., about 160° C. to about 170° C., or about 170° C. to about 180° C. A wet T_{g} onset is a glass transition temperature that is tested in a humid or wet environment, such as about 10% to about 100% humidity, such as about 10% to about 30%, about 30% to about 50%, about 50% to about 70%, or about 70% to about 100%. Without wishing to be bound by theory, a dry T_{g} onset that is greater than about 160° C. and a wet T_{g} onset greater than about 140° C. promote uniform operations in aerospace applications such that the structural aerospace components may be safely operated under high humidity and/or high temperatures.

In some embodiments, the crosslinked epoxy composition has a compression modulus 0° of about 110 GPa to about 120 GPa as measured by EN 2850, such as about 110 GPa to about 112 GPa, about 112 GPa to about 114 GPa, about 114 GPa to about 116 GPa, about 116 GPa to about 118 GPa, or about 118 GPa to about 120 GPa.

In some embodiments, the crosslinked epoxy composition has a compression strength at 0° of about 700 MPa to about 950 MPa as measured by EN 2850, such as about 700 MPa to about 800 MPa, about 800 MPa to about 900 MPa, or about 900 MPa to about 950 MPa.

In some embodiments, the crosslinked epoxy composition has a tensile modulus at 0° of about 120 GPa to about 140 GPa, as measured by DIN EN ISO 527-4, such as about 120 GPa to about 124 GPa, about 124 GPa to about 128 GPa, about 128 GPa to about 132 GPa, about 132 GPa to about 136 GPa, or about 136 GPa to about 140 GPa.

In some embodiments, the crosslinked epoxy composition has a tensile modulus at 90° of about 9 GPa to about 10 GPa, as measured by DIN EN ISO 527-4, such as about 9.1 GPa to about 9.4 GPa, about 9.4 GPa to about 9.6 GPa, about 9.6 GPa to about 9.8 GPa, or about 9.8 GPa to about 10 GPa.

In some embodiments, the crosslinked epoxy composition has a tensile strength at 0° of about 1600 MPa to about 1800 MPa, as measured by DIN EN ISO 527-4, such as about 1600 MPa to about 1650 MPa, about 1650 MPa to about 1700 MPa, about 1700 MPa to about 1750 MPa, or about 1750 MPa to about 1800 MPa.

In some embodiments, the crosslinked epoxy composition has a tensile strength at 900 of about 35 MPa to about 50 MPa, as measured by DIN EN ISO 527-4, such as about 35 MPa to about 40 MPa, about 40 MPa to about 45 MPa, or about 45 MPa to about 50 MPa.

Without being bound by theory, the epoxy resin composition of the present disclosure can provide comparable chemical properties as compared to comparative epoxy resins, while maintaining a faster cure time and a sufficient T_{g} onset.

### Methods

Methods of the present disclosure can include forming an epoxy resin composition by providing an epoxy component and a curing agent component into a resin transfer molding system. A resin transfer molding (RTM) system may include 1, 2, or 3 storage tanks, which can be temperature controlled and/or pressure controlled, such as vacuum controlled. The RTM system can include a low pressure RTM (LP RTM), such as less than 120 bar, which includes a static mixer. The RTM system can include a high pressure RTM which includes a high pressure such as mixing head (HP RTM) such as about 120 bar to about 160 bar, such as about 120 bar to about 140 bar or about 140 bar to about 160 bar. The RTM may dose, such as via injection, a component into a tool, such as a press. The resin transfer molding system may mix the curing agent component and the epoxy component at a ratio of about 2.1:1 mol/mol to about 3:1 mol/mol, such as about 2:1 mol/mol, about 2.4:1 mol/mol, about 2.6:1 mol/mol, about 2.8:1 mol/mol, or about 3:1 mol/mol,

A structural aerospace component may be disposed in the resin transfer molding system. A structural aerospace component may include one or more of a glass component, a carbon component, polymer component, or a metal component. For example, the structural aerospace component may include a carbon fiber component, such as graphene, graphite, single-walled nanotubes, or double-walled nanotubes. In some embodiments, a carbon component composition has about 50 wt % to about 70 wt % of carbon component and about 30 wt % to about 50 wt % of epoxy resin composition.

The method includes disposing the epoxy resin composition of the resin transfer molding system on or over the structural aerospace component such that the mixture covers and/or intercalates into at least a portion of the aerospace component. In an embodiment, the epoxy resin composition may be injected by the resin transfer molding system at an injection speed of about 1 g/sec to about 200 g/sec, such as about 10 g/sec to about 100 g/sec, about 100 g/sec to about 150 g/sec, or about 150 g/sec to about 200 g/sec. Without being bound by theory, an injection speed that is greater may be used for larger aerospace components, such as wings, where an injection speed that is slower may be used for smaller aerospace components, such as switches.

The epoxy resin composition is then crosslinked at a curing temperature of about 120° C. to about 190° C., such as about 120° C. to about 130° C., about 130° C. to about 140° C., about 140° C. to about 150° C., about 150° C. to about 160° C., about 160° C. to about 170° C., about 170° C. to about 180° C., or about 180° C. to about 190° C. The epoxy resin composition may be crosslinked for about 30 seconds to about 30 min, such as about 30 seconds to about 1 min, about 1 min to about 5 min, about 5 min to about 10 min, about 10 min to about 15 min, about 15 min to about 20 min, about 20 min to about 25 min, or about 25 min to about 30 min. For example, the epoxy resin composition may be crosslinked at a temperature of about 170° C. for a period of about 15 min. For example, the epoxy resin composition may be crosslinked at a temperature of about 120° C. for a period of about 30 min. Without being bound by theory, a curing time of about 15 minutes reduces the processing time to allow for faster production of aerospace components, which reduces production costs.

In at least one an embodiment, the epoxy resin composition may undergo gelation at about 30 seconds to about 5 min, such as about 30 seconds to about 1 min, about 1 min to about 2 min, about 2 min to about 3 min, about 3 min to about 4 min, or about 4 min to about 5 min, in which the time to gelation is the amount of time for processing and/or injection of the mixture. Without being bound by theory, a faster gelation may promote reduced or eliminated runaway reaction during the formation of the crosslinked epoxy resin due to the fast initial gelation of epoxy compounds and/or curing agent component compounds followed by substantially complete curing.

In at least one embodiment, the epoxy resin composition may be crosslinked at a first temperature for a first period of time and subsequently crosslinked at a second temperature for a second period of time. The first temperature and the second temperature may be the same or different. For example, the epoxy resin composition may be crosslinked at a first temperature of about 120° C. for a period of about 30 min, where the resin transfer molding system may adjust to a second temperature of about 170° C. and cure the epoxy resin composition for a period of about 15 min. In at least one embodiment, the resin transfer molding system cure the epoxy resin composition by ramping the temperature from room temperature, such as about 20° C. to about 25° C., to the curing temperature, such as about 120° C. to about 190° C., and holding the curing temperature for a period of time, such as about 30 seconds to about 1 min, about 1 min to about 5 min, about 5 min to about 10 min, about 10 min to about 15 min, about 15 min to about 20 min, about 20 min to about 25 min, or about 25 min to about 30 min. Without being bound by theory, a curing temperature of about 170° C. may reduce a gelling time of the mixture from about 4 minutes to less than one minute to increase a viscosity of the epoxy resin composition such that the epoxy resin composition will not fall off the aerospace component, which reduces the need for additional epoxy resin composition to be disposed on the aerospace component.

Methods of the present disclosure can also include forming an epoxy resin composition by providing an epoxy component and a curing agent component into a processing system, such as a pre-peg system, where the epoxy resin system is embedded in a textile component or other component suitable for being embedded with the epoxy resin composition. The processing system may include a laminating system. The laminating system can include a system that provides a mixture of the epoxy component and the curing agent component onto a component, where the mixture is mechanically spread on the component. The processing system can include an infusion system. The infusion system can include an open system or a closed system. The infusion system includes a storage tank that holds a mixture of the epoxy component and the curing agent component. The infusion system includes a preform that is located in the infusion system with one or more screws or a vacuum construction with foils. The infusion system includes a vacuum pump that allows the epoxy resin composition to flow from a first side of the preform to a second side of the preform such that infusion occurs in the preform. The infused epoxy resin composition may then be cured. Methods of the present disclosure can also include forming an epoxy resin composition by providing an epoxy component and a curing agent component into a compression system. A compression system can include a compression press that mechanically forces the epoxy resin composition onto or into the component.

### Examples

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

A crosslinked epoxy resin composition of the present disclosure was produced by mixing about 100 g of an epoxy component including 25 wt % Bisphenol A diglycidyl ether, 25 wt % tetramethyl bisphenol F-diglycidyl ether, and 50 wt % of 4,4′-methylenebis[N,N-bis(2,3-epoxypropyl)aniline] with about 37.2 g of a curing agent component including 40 wt % of 3-aminomethyl-3,5,5-trimethylcyclohexylamine and 60 wt % of a mixture of 48.5 wt % 3-aminomethyl-3,5,5-trimethylcyclohexylamine and 51.5 wt % phenol,4,4′-(1-methylethylidene)bis-polymer with 5-amino-1,3,3-trimethylcyclohexanemethanamine and (chloromethyl)oxirane, as shown in Tables 1 and 2.

TABLE 1
Epoxy component

| Compound | wt % | Chemical Name | CAS Number |
|---|---|---|---|
| 1 | 25 | Bisphenol A diglycidyl ether | 1675-54-3 |
| 2 | 25 | tetramethyl bisphenol F - diglycidyl ether | 113693-69-9 |
| | | | 93705-66-9 |
| 3 | 50 | 4,4′-methylenebis[N,N-bis(2,3-epoxypropyl)aniline] | 28768-32-3 |

TABLE 2
Curing agent component

| | | | | CAS |
|---|---|---|---|---|
| Compound | wt % | Chemical Name | | Number |
| 1 | 40 | 3-aminomethyl-3,5,5-trimethylcyclohexylamine | | 2855-13-2 |
| 2 | 60 | wt % | Chemical Name | 2855-13-2 |
| | | 48.5% | 3-aminomethyl-3,5,5- | |
| | | | trimethylcyclohexylamine | |
| | | 51.5% | phenol, 4,4′-(1-methylethylidene)bis-, | 38294-64-3 |
| | | | polymer with 5-amino-1,3,3- | |
| | | | trimethylcyclohexanemethanamine and | |
| | | | (chloromethyl)oxirane | |

The crosslinked epoxy resin composition was cured for 15 min at 170° C., and two samples were analysed. Sample 1 includes a neat crosslinked epoxy resin having no fibers, where sample includes a crosslinked epoxy resin having about 61 wt % of fibers. The reaction enthalpy was determined according to DIN 53445. The gel point was determined according to DIN 16945. The dry where the dry T_{g} onset and wet T_{g} onset were determined according to DIN EN 61006. The moisture uptake was determined by DIN EN 2823, which was modified by placing the sample in boiling water for 48 hours. The interlaminar shear strength (ILSS) was determined according to interlaminar shear strength (ILSS). Results are shown in Table 3.

TABLE 3
Crosslinked Epoxy Resin Composition

| Property | Sample 1 | Sample 2 |
|---|---|---|
| DMA Dry T_{g onset} | 190 | 201 |
| DMA Wet T_{g onset} | 170 | 169 |
| Gel Point [Rheology, oscillation at 140° C.] (min) | 2.5 | |
| DSC: Reaction enthalpy (J/g) | 497 | |
| DSC: Tg Onset Temperature | 185 | 201 |
| Moisture uptake (wt %) | | 0.78 |
| ILSS Dry 0° | | 50 |
| ILSS Dry 90° | | 44 |
| ILSS Wet 0° | | 50 |
| ILSS Wet 90° (MPa) | | 45 |

The crosslinked epoxy resin composition presented a low moisture uptake, which may indicate longer shelf-life when cured, decreasing required maintenance.

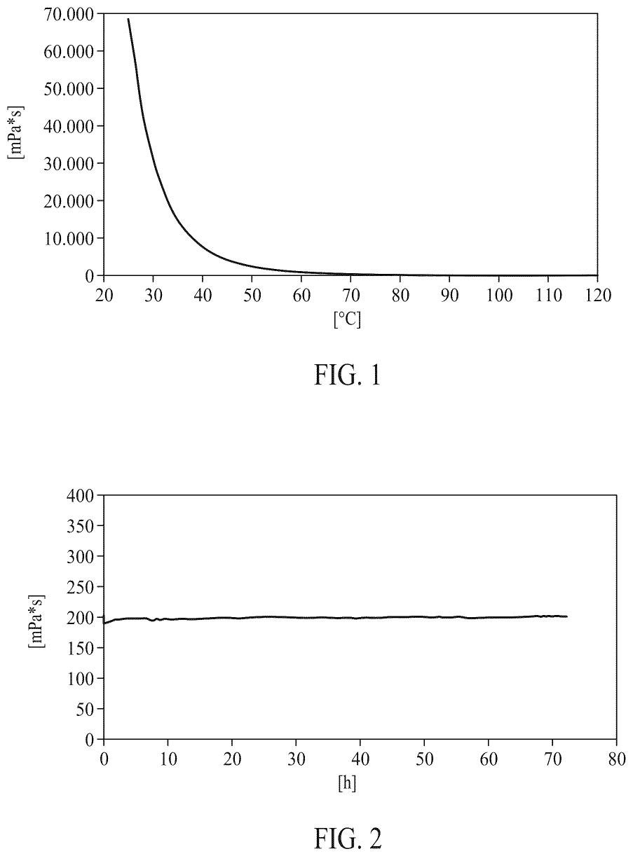

Now referring to FIG. 1, a viscosity vs. temperature graph is shown for the epoxy component. At room temperature, such as about 25° C., the viscosity was around 68 Pa*s, which dropped to about 8 Pa*s at a temperature of about 40° C. The viscosity then continued to drop to less than 200 mPa*s as the temperature approached 120° C. Without being bound by theory, a viscosity that is less than 200 mPa*s allows for an increase in processability of the epoxy resin composition.

Now referring to FIG. 2, a viscosity vs. time graph is shown for the epoxy component. The viscosity of the epoxy component was stable through 70 hours at about 200 mPa*s. Without being bound by theory, a viscosity that is stable through 70 hours at about 200 mPa*s allows for an improved shelf life of the epoxy component.

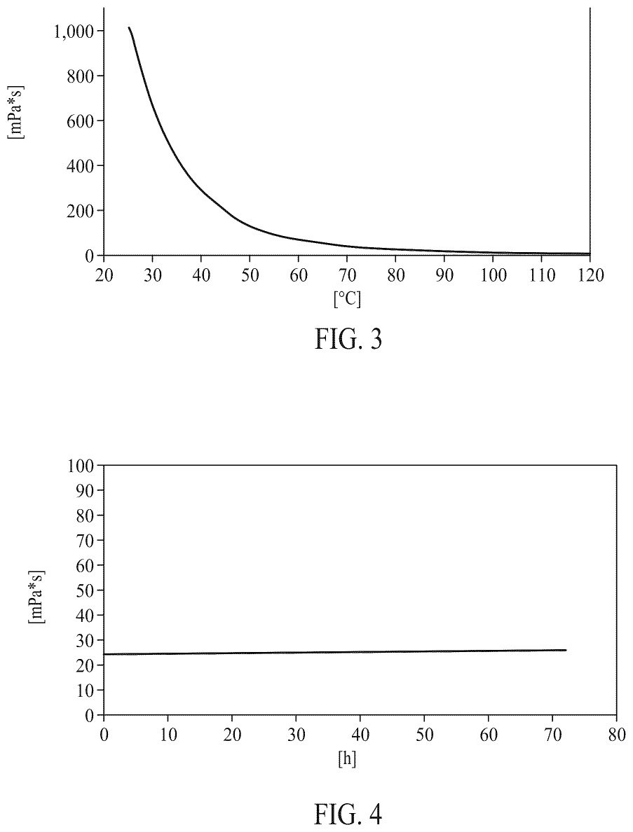

Now referring to FIG. 3, a viscosity vs. temperature graph is shown for the curing agent component. At room temperature, such as about 25° C., the viscosity was around 1,000 mPa*s, which dropped to about 300 mPa*s at a temperature of about 40° C. The viscosity then continued to drop to less than 50 mPa*s as the temperature approached 120° C. By having a dropping viscosity based on temperature the curing agent component may be incorporated to a plurality of processes due to the ability to cure at temperatures of room temperature up to 120° C. Additionally, due to the curing agent component being capable of curing at a lower temperature, a reduction of aging in the curing agent component may occur.

Now referring to FIG. 4, a viscosity vs. time graph is shown for the curing agent component. The viscosity of the curing agent component was stable through 70 hours at about 25 mPa*s, when testing at 80° C. By having stability through 70 hours, the curing agent component may avoid aging, which allows for reactions to proceed even after storage for a period of time, such as seconds, days, weeks, months, or years.

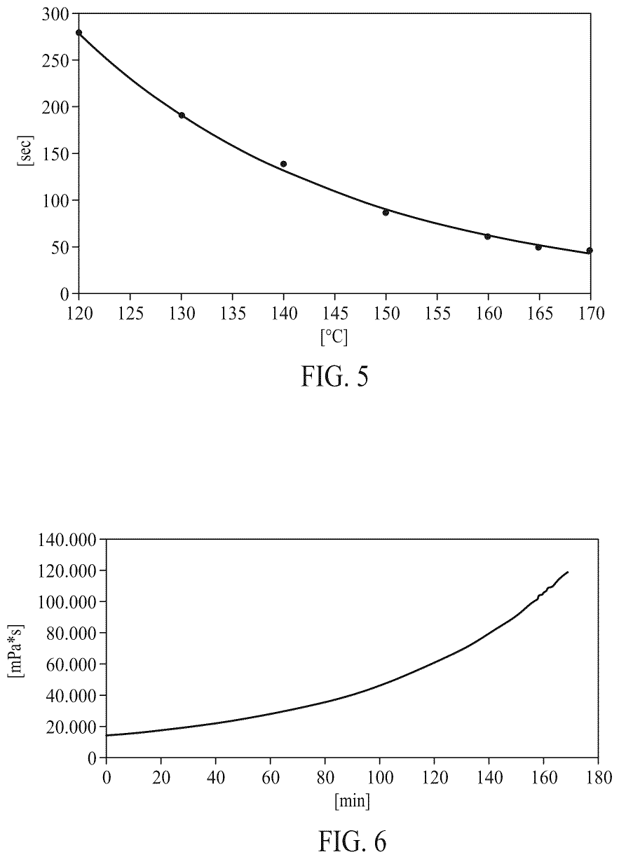

Now referring to FIG. 5, a hot plate gel time vs. temperature graph is shown for the epoxy resin composition. Gelation of the epoxy resin composition occurred at a speed of about 280 seconds when curing at a temperature of about 120°, while gelation occurred faster, such as about 50 seconds, when curing at a temperature of 170° C. Without being bound by theory, by curing at a lower temperature, and having a longer gelation time, more epoxy resin composition may be injected while the epoxy resin composition may be processed, which allows for larger parts to be produced in one coating process.

Now referring to FIG. 6, a viscosity vs. time graph is shown for the epoxy resin composition. The temperature was about 25° C., where the viscosity of the epoxy resin composition increased from a viscosity of about 18 Pa*s to a viscosity of about 120 Pa*s after about 170 min. Without being bound by theory, a viscosity increase indicates that the epoxy resin composition cures even at a temperature of about 25° C.

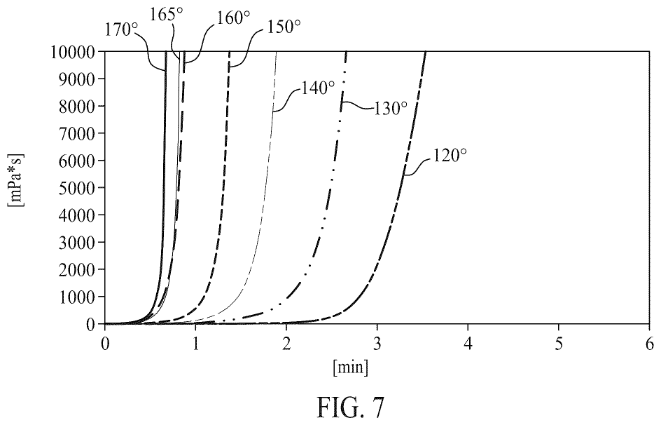

Now referring to FIG. 7, a viscosity vs. time graph is shown for the epoxy resin composition when cured at different temperatures. An epoxy resin composition that was cured at a temperature of about 170° C. increased in viscosity at a faster rate, such as about 40-60 seconds, compared to an epoxy resin composition that was cured at a temperature of about 120° C., such as about 4 min. Without being bound by theory, a higher cure temperature may cause the epoxy resin composition to cure at a faster rate, allow for increased production of aerospace components due to the reduced processing time.

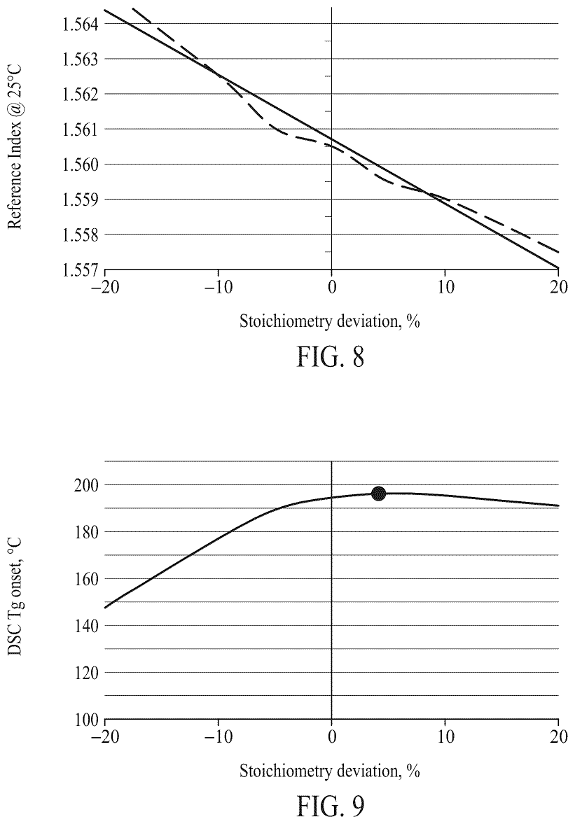

Now referring to FIG. 8, a refractive index vs. stoichiometry deviation is shown for the epoxy resin composition. The epoxy resin composition showed a refractive index of about 1.56075 when the stoichiometry deviation percent was 0%. Without being bound by theory, the mixing ratio may be validated using the refractive index to ensure proper formation of the epoxy resin composition.

Now referring to FIG. 9, a T_{g} onset vs. stoichiometry deviation is shown for the epoxy resin composition. The epoxy resin composition showed a T_{g} on set of about 195° C. when the stoichiometry deviation percent was 0%. The T_{g} onset remained about 195° C. when the stoichiometry deviation percent was about 5%. Without being bound by theory, a T_{g} onset that remains stable even during stoichiometric deviations allows for consistency of the T_{g} onset when there is an incorrect mixing ratio, which increases the ease of use of the epoxy resin composition.

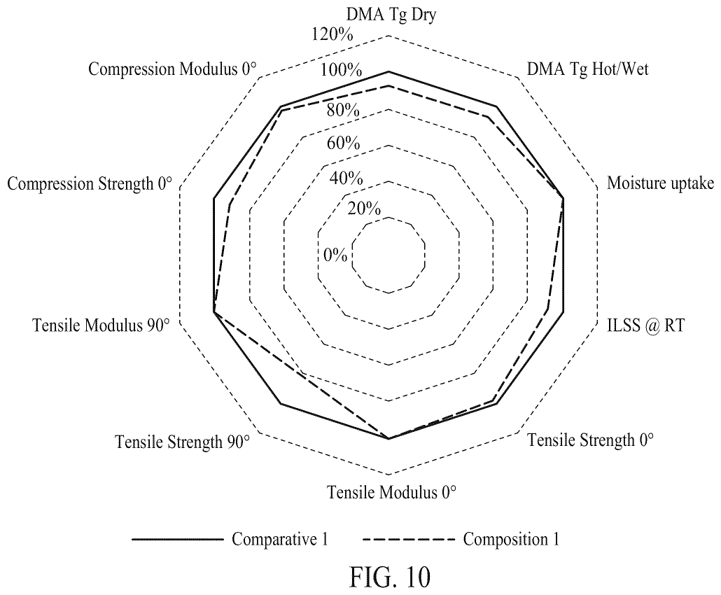

Now referring to FIG. 10, mechanical properties are shown for the epoxy resin composition compared to a comparative composition. The epoxy resin composition showed similar and/or equal chemical properties to the comparative epoxy resins, but with a faster cure time and a sufficient T_{g} onset. The comparable chemical properties of the epoxy resin composition along with the faster cure time allows for faster production of components suitable for the aerospace or automotive industry. The comparative composition had a compression modulus 0° of about 110 GPa to about 130 GPa as measured by EN 2850. The comparative composition had a compression strength at 0° of about 1000 MPa to about 1300 MPa as measured by EN 2850. The comparative composition had a tensile modulus at 00 of about 125 GPa to about 135 GPa, as measured by DIN EN ISO 527-4. The comparative composition had a tensile modulus at 90 of about 8 GPa to about 10 GPa, as measured by DIN EN ISO 527-4. The comparative composition had a tensile strength at 0° of about 1800 MPa to about 2200 MPa, as measured by DIN EN ISO 527-4. The comparative composition had a tensile strength at 90° of about 35 MPa to about 80 MPa, as measured by DIN EN ISO 527-4, as shown in Table 4.

TABLE 4
Comparative mechanical properties

| | | | Comparative 1 | |
|---|---|---|---|---|
| | | | UD fabric1) | |
| Property | Test Method | Unit | Dry, 23° C. | Wet, 70° C. |
| Tg (E′ onset) | DIN EN | ° C. | 205 ± 5 | 177 ± 5 |
| Tg (peak tan delta) | 6032 | | 214 ± 5 | 189 ± 5 |
| Warp Tensile | DIN EN ISO | MPa | 2051 ± 100 | 1886 ± 80 |
| Strength (0°) | 527-4 | | | |
| Warp Tensile | | GPa | 129 ± 2 | 130 ± 2 |
| Modulus (0°) | | | | |
| Weft Tensile | | MPa | 63 ± 15 | 41 ± 8 |
| Strength (90°) | | | | |
| Weft Tensile | | GPa | 9.3 ± 0.2 | 8.8 ± 0.2 |
| Modulus (90°) | | | | |
| Warp Compression | EN 2850 | MPa | 1110 ± 100 | N/D |
| Strength (0°) | | | | |
| Warp Compression | | GPa | 124 ± 4 | N/D |
| Modulus (0°) | | | | |
| Weft Compression | | MPa | 221 ± 8 | N/D |
| Strength (90°) | | | | |
| Weft Compression | | GPa | 11 ± 0.5 | N/D |
| Modulus (90°) | | | | |
| Warp Interlaminar | EN 2563 | MPa | 95 ± 3 | 73 ± 3 |
| Shear Strength | | | | |
| (0°) | | | | |
| In-plane Shear | DIN EN ISO | MPa | 112 ± 5 | 83 ± 8 |
| Strength | 14129 | | | |
| In-plane Shear | | GPa | 4.2 ± 0.3 | 3.7 ± 0.3 |
| Modulus | | | | |
| Interlaminar | DIN EN | J/m² | 593 ± 80 | 523 ± 80 |
| Fracture | 6033 | | | |
| Toughness Mode | | | | |
| I, G1C | | | | |
| Interlaminar | DIN EN | | 1434 ± 200 | 1453 ± 200 |
| Fracture | 6034 | | | |
| Toughness Mode | | | | |
| II, G2C | | | | |
| Open Hole | DIN EN | MPa | 271 ± 10 | 238 ± 10 |
| Compression | 6036 | | | |
| Strength | | | | |
| Filled Hole | | | 368 ± 20 | 341 ± 25 |
| Compression | | | | |
| Strength | | | | |
| Compression | DIN ISO | MPa | 249 ± 10 | 217 ± 10 |
| Strength | 18352 | | | |
| After Impact | | | | |
| (30J) | | | | |

The epoxy resin composition had a compression modulus 0° of about 110 GPa to about 120 GPa as measured by EN 2850. The comparative composition had a compression strength at 0° of about 700 MPa to about 950 MPa as measured by EN 2850. The comparative composition had a tensile modulus at 0° of about 120 GPa to about 140 GPa, as measured by DIN EN ISO 527-4. The comparative composition had a tensile modulus at 90° of about 9 GPa to about 10 GPa, as measured by DIN EN ISO 527-4. The comparative composition had a tensile strength at 0° of about 1600 MPa to about 1800 MPa, as measured by DIN EN ISO 527-4. The comparative composition had a tensile strength at 90° of about 35 MPa to about 50 MPa, as measured by DIN EN ISO 527-4. Without being bound by theory, the epoxy resin composition of the present disclosure showed comparable chemical properties to the comparative epoxy resins, while maintaining a faster cure time and a sufficient T_{g} onset, as shown in Table 5.

TABLE 5
Epoxy resin composition mechanical properties

| | | | Composition 1 | |
|---|---|---|---|---|
| | | | | Curing at |
| | | | | 120° C. for |
| | | | Curing at | 30 min & |
| | | | 170° C. | post cure |
| | | | for 15 | at 170° C. |
| Property | Test Method | Unit | minutes | for 15 min |
| T_{g} (E′ onset) | DIN EN | ° C. | 182 | 185 |
| | 6032 | | | |
| T_{g} (peak tan delta) | | | 205 | 216 |
| Warp Tensile | DIN EN ISO | MPa | 1640 | 1740 |
| Strength (0°) | 527-4 | | | |
| Warp Tensile | | GPa | 136 | 129 |
| Modulus (0°) | | | | |
| Weft Tensile | | MPa | 45.1 | 39.9 |
| Strength (90°) | | | | |
| Weft Tensile | | GPa | 9.85 | 9.81 |
| Modulus (90°) | | | | |
| Warp Compression | EN 2850 | MPa | 782 | 910 |
| Strength (0°) | | | | |
| Warp Compression | | GPa | 117 | 113 |
| Modulus (0°) | | | | |
| Weft Compression | | MPa | 214 | 199.8 |
| Strength (90°) | | | | |
| Weft Compression | | GPa | 10.5 | 9.2 |
| Modulus (90°) | | | | |
| Warp Interlaminar | EN 2563 | MPa | 87 | 80 |
| Shear Strength (0°) | | | | |
| In-plane Shear | DIN EN ISO | MPa | 64 | 63 |
| Strength | 14129 | | | |
| In-plane Shear | | GPa | 4.2 | 4.2 |
| Modulus | | | | |

The comparative composition had a resistance towards media of methyl ethyl ketone, fuel, Skydrol™ (available from Eastman Aviation Solutions), propylene glycol, ABC-S™ Type IV (Available by Killfrost), and non-phenolic paint stripper as tested by EN 2563, as shown in Table 6.

TABLE 6
Comparative Fluid Resistance

| Environment/ | | | Test | |
|---|---|---|---|---|
| Fluids | Method | Conditioning | Condition | ILSS Value |
| Dry | EN-2563 | None | Room | 84 +/− 6 |
| | | | temperature; | |
| | | | 46% relative | |
| | | | humidity | |
| Hot-Wet | | 70° C. & 85% | 120° C. | 50 +/− 2 |
| | | relative | | |
| | | humidity to | | |
| | | saturation | | |
| Methyl ethyl | | 1 hour at room | Room | 87 +/− 1 |
| ketone | | temperature | temperature; | |
| | | | 46% relative | |
| | | | humidity | |
| Fuel | | 1000 hour at | Room | 87 +/− 2 |
| | | room | temperature; | |
| | | temperature | 45% relative | |
| | | | humidity | |
| Fuel | | 1000 hour at | 70° C. | 72 +/− 1 |
| | | room | | |
| | | temperature | | |
| Skydrol | | 1000 hour at | 70° C. | 67 +/− 1 |
| | | 70° C. | | |
| Skydrol- | | 1000 hour at | 70° C. | 60 +/− 3 |
| Water-Mix | | 50° C. | | |
| Propylene | | 1000 hour at | 70° C. | 75 +/− 1 |
| Glycol | | 70° C. | | |
| ABC-S | | 1000 hour at | 70° C. | 66 +/− 1 |
| | | 70° C. | | |
| Non-phenolic | | — | Room | 86 +/− 1 |
| paint stripper | | | temperature; | |
| | | | 45% relative | |
| | | | humidity | |

The epoxy resin composition had a resistance towards media of methyl ethyl ketone, fuel, Skydrol™ (available from Eastman Aviation Solutions), propylene glycol, ABC-S™ Type IV (Available by Killfrost), and non-phenolic paint stripper as tested by EN 2563, as shown in Table 7.

### Embodiments Listing

The present disclosure provides, among others, the following aspects, each of which can be considered as optionally including any alternate embodiments:

E1. An epoxy resin composition, an epoxy component comprising a first epoxy compound that is a bisphenol A diglycidyl ether compound; a second epoxy compound that is a diglycidyl aniline compound; and a curing agent component comprising: a first polyamine compound; and a second polyamine compound, wherein the second polyamine compound comprises an adduct of a polyamine compound.

E2. The epoxy resin composition of embodiment E1, wherein the epoxy resin composition further comprises a third epoxy compound.

E3. The epoxy resin composition of embodiment E2, wherein the third epoxy compound comprises a tetramethyl bisphenol F-diglycidyl ether compound.

E4. The epoxy resin composition of embodiment E2 or E3, the first epoxy compound is present in the epoxy component at about 20 wt % to about 30 wt %, the second epoxy compound is present in the epoxy component at about 20 wt % to about 60 wt %, and the third epoxy compound is present in the epoxy component at about 20 wt % to about 60 wt %, based on total weight of the epoxy component, wherein the total weight does not exceed 100 wt %.

E5. The epoxy resin composition of any one of embodiments E1-E4, wherein the first polyamine compound comprises an isophorone diamine compound.

E6. The epoxy resin composition of embodiment E5, wherein the isophorone diamine is 3-aminomethyl-3,5,5-trimethylcyclohexylamine.

E7. The epoxy resin composition of any one of embodiments E1-E6, wherein the second polyamine compound comprises an isophorone diamine adduct compound.

E8. The epoxy resin composition of embodiment E7, wherein the isophorone diamine adduct compound is phenol, 4,4′-(1-methylethylidene)bis-polymer with 5-amino-1,3,3-trimethylcyclohexanemethanamine and (chloromethyl)oxirane.

E9. The epoxy resin composition of embodiment E8, the first polyamine compound is about 30 wt % to about 50 wt %, based on total weight of the curing agent component, and the second polyamine compound is about 50 wt % to about 70 wt %, based on total weight of the curing agent component, wherein the total weight does not exceed 100 wt %.

E10. A crosslinked epoxy resin that is the reaction product of: an epoxy component comprising a first epoxy compound that is a bisphenol A diglycidyl ether compound and a second epoxy compound that is a diglycidyl aniline compound; and a curing agent component comprising a first polyamine compound and a second polyamine compound, wherein the second polyamine compound is an adduct of a polyamine compound.

E11. The crosslinked epoxy resin composition of any one of embodiments E1-E10, wherein the crosslinked epoxy resin is cured at a temperature of about 120° C. to about 130° C. for a period of about 20 to about 30 minutes.

E12. The crosslinked resin composition of any one of embodiments E1-E11, wherein the crosslinked epoxy resin composition is cured at a temperature of about 160° C. to about 170° C. for a period of about 10 minutes to about 20 minutes.

E13. The crosslinked epoxy resin composition of any one of embodiments E1-E12, wherein the crosslinked epoxy resin composition has a dry glass transition temperature (Tg) onset of about 160° C. to about 210° C.

E14. The crosslinked epoxy resin composition of any one of embodiments E1-E13, wherein the crosslinked epoxy resin composition has a wet glass transition temperature (Tg) onset of about 140° C. to about 180° C.

E15. A method of forming a crosslinked epoxy resin composition, the method comprising producing a mixture by providing an epoxy component and a curing agent component into a resin transfer molding system, wherein the epoxy component comprises a first epoxy compound that is a bisphenol A diglycidyl ether compound and a second epoxy compound that is a diglycidyl aniline compound, and wherein the curing agent component comprises a first polyamine compound and a second polyamine compound, wherein the second polyamine compound is an adduct of a polyamine compound; disposing a component in the resin transfer molding system; disposing the mixture on the component, and forming the crosslinked epoxy resin composition by curing the mixture on the component.

E16. The method of embodiment E15, wherein producing the mixture comprises mixing the epoxy component and the curing agent component at a ratio of about 2:1 mol/mol to about 3:1 mol/mol.

E17. The method of embodiment E15 or E16, wherein disposing the mixture on the structural aerospace component comprises injecting the mixture on to the structural aerospace component at an injection speed of about 1 g/sec to about 200 g/sec.

E18. The method of anyone of embodiments E15-E17, wherein curing the mixture comprises curing at a temperature of about 120° C. to about 180° C. for a period of about 10 minutes to about 30 minutes.

E19. The method of embodiment E18, wherein curing the mixture comprises curing at a temperature of about 120° C. to about 130° C. for a period of about 20 to about 30 minutes.

E20. The method of embodiment E18, wherein curing the mixture comprises curing at a temperature of about 160° C. to about 170° C. for a period of about 10 minutes to about 20 minutes.

E21. The method of any one of embodiments E15-E20, wherein curing the mixture comprises curing the mixture at a first temperature for a first period of time and curing the mixture at a second temperature for a second period of time, wherein the first temperature is different than the second temperature and the first period of time is the same as or different than the second period of time.

Overall, the epoxy resin compositions and methods of production thereof described herein can provide crosslinked epoxy resin compositions having a high T_{g} onset, such as greater than 140° C., after a short cure time, which reduces processing time, increases the number of aerospace components capable of being produced per unit time, and lowers the cost of producing aerospace components. Additionally, the epoxy resin compositions have an improved gelation time compared to conventional bi-component resin compositions, which promotes reduced or eliminated runaway reaction during the formation of the crosslinked epoxy resin.

Each of the foregoing numbers can be preceded by the word “about,” “at least about,” “less than about,” or “more than about,” and any of the foregoing numbers can be used singly to describe an open-ended range or in combination to describe a close-ended range.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a monomer” include aspects comprising one, two, or more monomers, unless specified to the contrary or the context clearly indicates only one monomer is included.

While the foregoing is directed to aspects of the present disclosure, other and further aspects of the disclosure may be devised without departing from the basic scope thereof, and the scope thereof is determined by the claims that follow.

What is claimed is:

1. An epoxy resin composition, comprising:
an epoxy component comprising:
a first epoxy compound that is a bisphenol A diglycidyl ether compound;
a second epoxy compound that is a diglycidyl aniline compound; and
a curing agent component comprising:
a first polyamine compound; and
a second polyamine compound, wherein the second polyamine compound comprises an adduct of a polyamine compound.

2. The epoxy resin composition of claim 1, wherein the epoxy resin composition further comprises a third epoxy compound.

3. The epoxy resin composition of claim 2, wherein the third epoxy compound comprises a tetramethyl bisphenol F-diglycidyl ether compound.

4. The epoxy resin composition of claim 3, wherein:
the first epoxy compound is present in the epoxy agent at about 20 wt % to about 30 wt %,
the second epoxy compound is present in the epoxy component at about 20 wt % to about 60 wt %, and
the third epoxy compound is present in the epoxy component at about 20 wt % to about 60 wt %, based on total weight of the epoxy component, wherein the total weight does not exceed 100 wt %.

5. The epoxy resin composition of claim 1, wherein the first polyamine compound comprises an isophorone diamine compound.

6. The epoxy resin composition of claim 5, wherein the isophorone diamine compound is 3-aminomethyl-3,5,5-trimethylcyclohexylamine.

7. The epoxy resin composition of claim 1, wherein the second polyamine compound comprises an isophorone diamine adduct compound.

8. The epoxy resin composition of claim 7, wherein the isophorone diamine adduct compound is phenol, 4,4′-(1-methylethylidene)bis-polymer with 5-amino-1,3,3-trimethylcyclohexanemethanamine and (chloromethyl)oxirane.

9. The epoxy resin composition of claim 1, wherein:
the first polyamine compound is about 30 wt % to about 50 wt %, based on total weight of the curing agent component, and
the second polyamine compound is about 50 wt % to about 70 wt %, based on total weight of the curing agent component,
wherein the total weight does not exceed 100 wt %.

10. A crosslinked epoxy resin composition that is the reaction product of:
an epoxy component comprising a first epoxy compound that is a bisphenol A diglycidyl ether compound and a second epoxy compound that is a diglycidyl aniline compound; and
a curing agent component comprising a first polyamine compound and a second polyamine compound, wherein the second polyamine compound is an adduct of a polyamine compound.

11. The crosslinked epoxy resin composition of claim 10, wherein the crosslinked epoxy resin is cured at a temperature of about 120° C. to about 130° C. for a period of about 20 to about 30 minutes.

12. The crosslinked epoxy resin composition of claim 10, wherein the crosslinked epoxy resin composition is cured at a temperature of about 160° C. to about 170° C. for a period of about 10 minutes to about 20 minutes.

13. The crosslinked epoxy resin composition of claim 10, wherein the crosslinked epoxy resin composition has a dry glass transition temperature (Tg) onset of about 160° C. to about 210° C.

14. The crosslinked epoxy resin composition of claim 10, wherein the crosslinked epoxy resin composition has a wet glass transition temperature (Tg) onset of about 140° C. to about 180° C.

15. A method of forming a crosslinked epoxy resin composition, the method comprising:
producing a mixture by providing an epoxy component and a curing agent component into a resin transfer molding system, wherein the epoxy component comprises a first epoxy compound that is a bisphenol A diglycidyl ether compound and a second epoxy compound that is a diglycidyl aniline compound, and wherein the curing agent component comprises a first polyamine compound and a second polyamine compound, wherein the second polyamine compound is an adduct of a polyamine compound;
disposing a component in the resin transfer molding system;
disposing the mixture on the component; and
forming the crosslinked epoxy resin composition by curing the mixture on the component.

16. The method of claim 15, wherein producing the mixture comprises mixing the epoxy component and the curing agent component at a ratio of about 2:1 mol/mol to about 3:1 mol/mol.

17. The method of claim 15, wherein disposing the mixture on the structural aerospace component comprises injecting the mixture on to the structural aerospace component at an injection speed of about 1 g/sec to about 200 g/sec.

18. The method of claim 15, wherein curing the mixture comprises curing at a temperature of about 120° C. to about 180° C. for a period of about 10 minutes to about 30 minutes.

19. The method of claim 18, wherein curing the mixture comprises curing at a temperature of about 120° C. to about 130° C. for a period of about 20 to about 30 minutes.

20. The method of claim 18, wherein curing the mixture comprises curing at a temperature of about 160° C. to about 170° C. for a period of about 10 minutes to about 20 minutes.

21. The method of claim 15, wherein curing the mixture comprises curing the mixture at a first temperature for a first period of time and curing the mixture at a second temperature for a second period of time, wherein the first temperature is different than the second temperature and the first period of time is the same as or different than the second period of time.
